(19) United States
(12) Patent Application Publication
(10) Pub. No.: US 2022/0223053 A1
(43) Pub. Date: Jul. 14, 2022

(54) METHOD AND SYSTEM FOR AUTONOMOUSLY TRACKING DISTRESS EVENTS ON AN AIRCRAFT IN REAL-TIME WHILE IN FLIGHT

(71) Applicant: SKYTRAC SYSTEMS LTD., Kelowna (CA)

(72) Inventors: Malachi NORDINE, Kelowna (CA); David James MARTIN, Victoria (CA); Jonathan Arthur GOERZEN, Kelowna (CA)

(21) Appl. No.: 17/631,801

(22) PCT Filed: Jul. 31, 2020
(86) PCT No.: PCT/CA2020/051058

§ 371 Date: Jan. 31, 2022

Related U.S. Application Data
(60) Provisional application No. 62/881,873, filed on Aug. 1, 2019.

(51) Int. Cl. G08G 5/00

(52) U.S. Cl. CPC G08G 5/0021; G08G 5/0082; G08G 5/0013

(57) ABSTRACT

Disclosed is a method and a system for autonomously tracking distress events on an aircraft in real-time while in flight. The method involves maintaining a multi-logic classifier configured for identifying distress events, receiving aircraft state data from at least one MAU (main avionics unit), transforming the aircraft state data using the multi-logic classifier to produce transformed state data, producing a trigger event if the transformed state data indicates a distress event, and generating an alert of the trigger event. In accordance with an embodiment of the disclosure, the multi-valued logic classifier is configured for identifying distress events using more than two possible truth values, for example by implementing a fuzzy logic algorithm or an artificial neural network. This is an improvement over conventional methods in which fixed thresholds are used to determine a Boolean true/false value to represent if an aircraft is in distress.

### RELATED APPLICATION

This patent application claims priority to U.S. Provisional Patent Application No. 62/881,873 filed on Aug. 1, 2019, the entire disclosure of which is incorporated by reference.

### FIELD OF THE DISCLOSURE

The present disclosure is related to electronic systems, and more particularly to electronic systems for tracking distress events on an aircraft.

### BACKGROUND

A conventional method of determining an emergency or distress condition of an aircraft involves evaluating a plurality of sensor measurements using fixed thresholds to determine a Boolean true/false value to represent if the aircraft is in distress. Unfortunately, this conventional method has issues with both false detection (i.e. giving a distress indication when none exist) and failure of detection (i.e. no indication that a distress condition is occurring). Both of these issues reduce a confidence in any distress annunciation, and thus may impact an effectiveness in any response to the distress annunciation. It is, therefore, desirable to provide a method and system that addresses the shortcomings of the conventional method.

### SUMMARY OF THE DISCLOSURE

Disclosed is a method for autonomously tracking distress events on an aircraft in real-time while in flight. The method involves maintaining a multi-logic logic classifier configured for identifying distress events, receiving aircraft state data from at least one MAU (main avionics unit), transforming the aircraft state data using the multi-logic classifier to produce transformed state data, producing a trigger event if the transformed state data indicates a distress event, and generating an alert of the trigger event.

In accordance with an embodiment of the disclosure, the multi-logic logic classifier is configured for identifying distress events using more than two possible truth values, for example by implementing a fuzzy logic algorithm or an artificial neural network. This is an improvement over the conventional method in which fixed thresholds are used to determine a Boolean true/false value to represent if an aircraft is in distress. In particular, by using the multi-valued logic classifier, it is possible to mitigate or avoid issues of false detection and failure of detection. As such, when the alert of the trigger event is generated, there can be a relatively high level of confidence in the alert, and thus it may be possible for an effective response to be actioned.

Also disclosed is a non-transitory computer readable medium having recorded thereon statements and instructions that, when executed by a processor of a system, implement the method as summarized above.

Also disclosed is a system that generally corresponds to the method summarized above.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of a system for autonomously tracking distress events on an aircraft in real-time while in flight;

FIG. 2 is a flow chart of a method for autonomously tracking distress events on an aircraft in real-time while in flight;

FIG. 3 is a process flow diagram depicting aircraft parameters to one of N distress inferences that can be stored for later review;

FIG. 4 is a process flow diagram depicting parameter membership processing into normal, excessive and marginal states based in expert knowledge conditioning;

FIG. 5 is an example membership function for an excessive ROLL parameter;

FIG. 6 is a schematic of an example calculation of a degree of distress using a fuzzy logic algorithm based on roll excessive, roll marginal and roll rate excessive;

FIG. 7 is a schematic of an example calculation of a degree of distress using a fuzzy logic algorithm based on IAS excessive, altitude low and over speed warning;

FIG. 8A to FIG. 8C are schematics of example calculations of degrees of distress using fuzzy logic algorithms based on excessive bank and excessive bank confirmed;

FIG. 9 are graphs depicting a distress inference over time;

FIG. 10 is a block diagram of another system for autonomously tracking distress events on an aircraft in real-time while in flight;

FIG. 11 is a block diagram of another system for autonomously tracking distress events on an aircraft in real-time while in flight; and

FIG. 12 is a flow chart of another method for autonomously tracking distress events on an aircraft in real-time while in flight.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

### Introduction

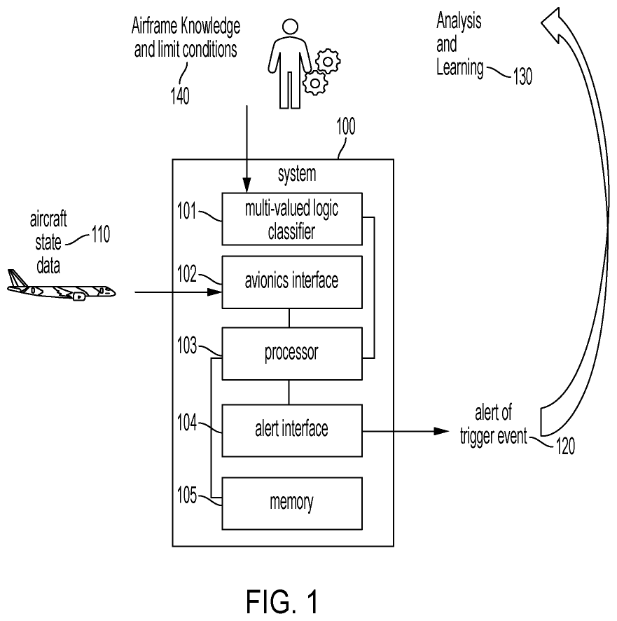

Referring first to FIG. 1, shown is a block diagram of a system 100 for autonomously tracking distress events on an aircraft in real-time while in flight. The system 100 has a multi-logic classifier 101 configured for identifying distress events, an avionics interface 102, a processor 103, and an alert interface 104. In some implementations, the system 100 also has a memory 105 as depicted. In addition, the system 100 can have other components that are not specifically shown.

When deployed, the system 100 can be disposed within the aircraft and is coupled to at least one MAU of the aircraft. By way of overview, the system 100 is configured to receive aircraft state data 110 from the at least one MAU, process the aircraft state data 110, and to generate an alert of a trigger event 120 when the system 100 determines that the aircraft may be in distress. The trigger event 120 can be advisory of pre-distress event (i.e. distress event may occur unless corrective action is taken), or advisory of an actual distress event (i.e. distress event is occurring or may occur imminently).

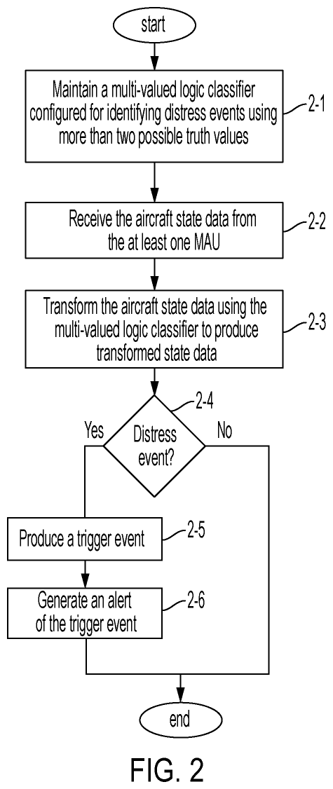

Operation of the system 100 of FIG. 1 will be described in further detail below with reference to FIG. 2, which is a flow chart of a method for autonomously tracking distress events on an aircraft in real-time while in flight. Although the method of FIG. 2 is described below with reference to the system 100 of FIG. 1, it is to be understood that the method of FIG. 2 is applicable to other systems. In general, the method of FIG. 2 is applicable to any appropriately configured system for autonomously tracking distress events on an aircraft in real-time while in flight.

At step 2-1, the system 100 maintains the multi-logic classifier 101, which is configured for identifying distress events. In some implementations, the multi-logic classifier 101 is software-based and executed on the processor 103, in which case maintaining the multi-logic classifier 101 can involve storing software and any associated configurations of the multi-logic classifier 101 in the memory 105. However, other implementations are possible, including hardware-based implementations, for example by using an FPGA (field programmable gate array) or a microcontroller to implement the multi-logic classifier 101.

At step 2-2, the system 100 receives aircraft state data 110 from the at least one MAU. In some implementations, the system 100 receives the aircraft state data 110 via the avionics interface 102. The aircraft state data 110 includes various data such as altitude, airspeed, pitch, roll, heading, engine, spoiler position, etc. The aircraft state data 110 includes real-time data that is dependent on the aircraft and its state. Prior to the aircraft entering a state of distress, there can be clues within the aircraft state data 110.

At step 2-3, the system 100 transforms the aircraft state data using the multi-valued logic classifier 101 to produce transformed state data. If at step 2-4 the transformed state data indicate a distress event, then at step 2-5 the system 100 produces a trigger event. In some implementations, the system 100 transforms the aircraft state data via the processor 103 implementing the multi-valued logic classifier 101, and produces the trigger event via the processor 103 as well. However, as noted above, other implementations are possible, including hardware-based implementations.

In accordance with an embodiment of the disclosure, the multi-valued logic classifier 101 is configured for identifying distress events using more than two possible truth values, for example by implementing a fuzzy logic algorithm or an artificial neural network. This is an improvement over the conventional method in which fixed thresholds are used to determine a Boolean true/false value to represent if an aircraft is in distress. In particular, by using the multi-valued logic classifier 101, it is possible to mitigate or avoid issues of false detection and failure of detection. Example details of how to identify distress events using more than two possible truth values are provided later.

Finally, at step 2-6, the system 100 generates an alert of the trigger event 120. In some implementations, the system 100 produces the alert of the trigger event 120 via the alert interface 104. In some implementations, the alert interface 104 generates the alert of the trigger event 120 to inform aircraft flight crew, including those that may be on the aircraft. In some implementations, the alert interface 104 generates the alert of the trigger event 120 to inform personnel outside of the aircraft (e.g. air traffic controllers), and hence some form of transmission is performed. When the alert of the trigger event 120 is generated, there can be a relatively high level of confidence in the alert, and thus it may be possible for an effective response to be actioned. In this way, it may be possible to achieve a successful resolution.

In some implementations, the system 100 stores distress event data and the aircraft state data relating to the distress event, for example in the memory 105. In some implementations, the distress event data and the aircraft state data relating to the distress event are subjected to analysis and learning 130, with a view to updating the multi-valued logic classifier 101 as appropriate. This provides a form of feedback for the multi-valued logic classifier 101, whereby adjustment can be made based on the feedback to tweak performance. For example, if the trigger event is advisory of an actual distress event, the multi-valued logic classifier 101 can be adjusted if possible to increase sensitivity to detect the distress event earlier, such that the trigger event that is generated is advisory of pre-distress event, thereby providing time for corrective action to avoid or mitigate the distress event. In some implementations, the adjusting of the multi-valued logic classifier 101 is performed based on airframe knowledge and limit conditions 140. This can involve some input by a user, with use of inference for expert refining of distress calculations. However, other implementations are possible in which adjustments can be performed via intelligent learning algorithms.

The way in which the adjustment is performed can vary based on the multi-valued logic classifier 101. For instance, in the case of a fuzzy logic algorithm incorporating fuzzy rules that apply membership functions to the aircraft state data to produce the transformed state data, there can be an adjustment of the membership functions, in accordance with the distress event data and the aircraft state data. Also, in the case of an artificial neural network algorithm incorporating functions based on weighted combinations of the aircraft state data, the there can be an adjustment of the weighted combinations, in accordance with the distress event data and the aircraft state data.

Some implementations improve on detection by identifying and eliminating false-positives and returning a decimal number that represents an inference level of state of distress instead of a Boolean value. This real-time recorded value can be used for both a more robust in-flight triggering method for distress conditions as well as the post flight review of distress progression. This can increase confidence in the reliable measurement, detection and reporting of aircraft distress conditions and thus is an improvement over the conventional method.

The Boolean approach of the conventional method does not allow an assessment of the degree of distress, i.e.: the aircraft is either in distress or it is not. Using a fuzzy logic approach to characterize a degree of distress provides additional granularity with respect to the severity of a potential distress condition and can facilitate more event mitigation options.

Some implementations reliably determines the inferences of aircraft state of distress in real-time based on the capture of a redundant plurality of aircraft state parameters and the application of optimized fuzzy logic mathematics to compare said aircraft operating states against known aircraft system and airframe operating knowledge and conditions.

Some implementations can determine the distress inference of an aircraft as a function of both the immediate aircraft operating parameters and the airframe and system envelope parameters. Some implementations map aircraft operating parameters and expert knowledge provided by airframe experts thought the use of intelligent rules-based algorithms to derive aircraft distress interferences. These algorithms can include, but are not limited to, the use of fuzzy logic/artificial intelligence.

The use of a single source of sensor input has shown to be problematic in distress determination should said sensor input fail to provide reliable measurements. The use of redundant distress processing of the same aircraft data derived from different sources and subsequently compared in a voting scheme can increase confidence in the distress inference. Corroborating data obtained by a GNSS (global navigation satellite system) and IMU (inertial measurement unit) data sources that are independent of, and uninfluenced by, the aircraft provided data can further improve distress inference processing.

Some implementations provide subsequent recording of said calculated aircraft state of distress for later review and further detection optimization. This stored prior distressed inferences can be used for intelligent feedback to optimize both the fuzzy logic membership functions and analysis so as to further improve future distress conditions inference.

Some implementations use the real-time available distress inference for the trigger of distress notification in accordance with GADSS (Regulated Global Aeronautical Distress and Safety System) by the ICAO (International Civil Aviation Organization). Some implementations improve distress inference calculation by reducing false and nuisance reporting of distress conditions.

Some implementations reliably determine of aircraft state of distress in real-time based on the capture of redundant plurality of aircraft state parameters and application of expert knowledge algorithms that can compare said aircraft operating states against known airframe safe operating knowledge.

Some implementations provide for system operation validation through self testing of the hardware circuits and a validation of processing against inputs with a-prior known analysis output.

Further example details are provided in the sections that follow below. Although many of the examples generally focus on implementations with a fuzzy logic algorithm, it is to be understood that other algorithms such as an artificial neural network algorithm are possible and are within the scope of the disclosure. More generally, any suitable algorithm that provides for a multi-logic logic classifier for identifying distress events using more than two possible truth values can be implemented.

### Fuzzy Logic Algorithm

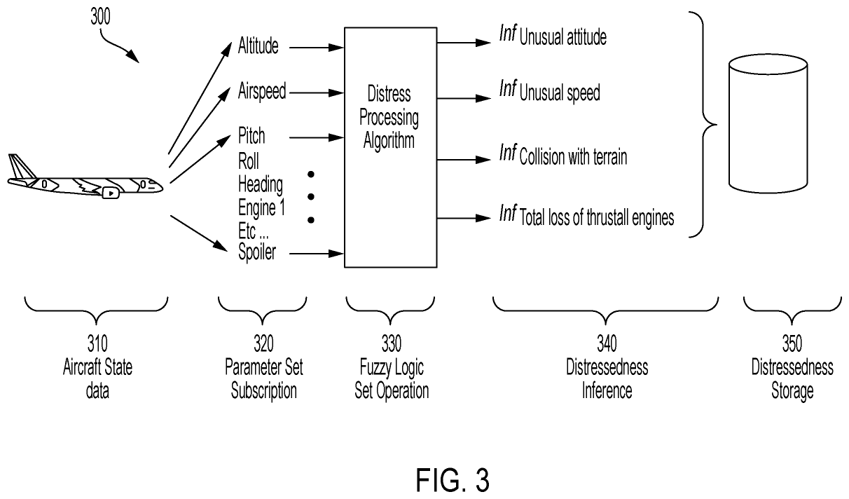

Referring now to FIG. 3, shown is a process flow diagram 300 depicting aircraft parameters 320 to one of N distress inferences 340 that can be stored 350 for later review. A plurality of parameter data 310 can be subscribed to and processed via membership functions 330. The distress scenario inferences 340 can be provided to a non-volatile storage media 350 so as to be available post flight regardless of flight mission success.

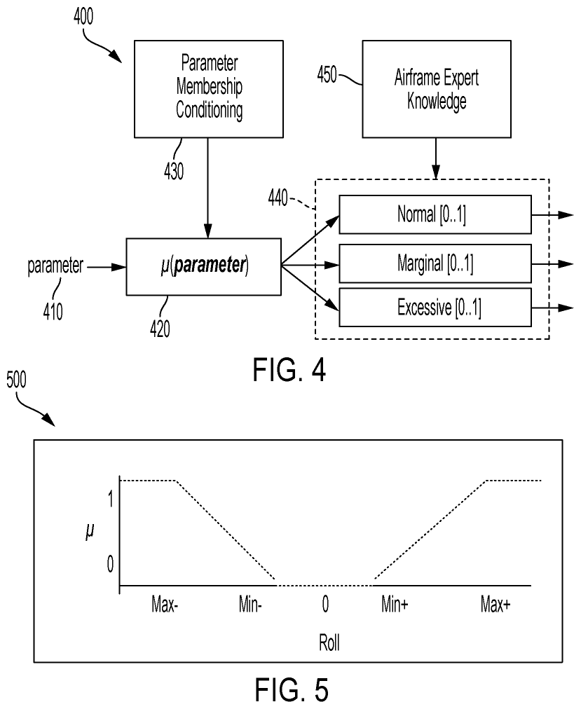

Referring now to FIG. 4, shown is a process flow diagram 400 depicting parameter membership processing into normal, excessive and marginal states based in expert knowledge conditioning. In some implementations, a fuzzy logic algorithm can first subscribe to the applicable aircraft state parameters 410 and can process said parameters through individual membership functions 440 that can transform the universal valued parameters into logistical values that can be described in natural language terms such as normal, excessive, or marginal. These natural language sets can range in value from 0 to 1 inferring the scale of how much the parameter is deemed ‘normal’ or ‘excessive’ in each case. FIG. 4 is a depiction of this processing of transforming universal values to membership sets.

In some implementations, the membership functions and input signal conditioning can be modified by configuration data 430 provided by expert knowledge 450 of the parameter and airframe to which the processing is applied. In some implementations, the membership functions and input signal conditioning can be modified based on the outputs of the membership functions 440. This provides a form of feedback in which adjustment can be made to tweak performance as similarly described earlier with reference to FIG. 1.

In some implementations, the fuzzy logic algorithm can use multiple membership functions, each of which can be tailored to provide a specific transformation of one of the real-world parameter values as appropriate with respect to the distress scenario being assessed. The transformation of each set can be a result of expert knowledge data that has been calculated for the specific airframe to which the system is applied. Again, the membership sets can include continuous values ranging from 0 to 1.

Referring now to FIG. 5, shown is an example membership function 500 for an excessive ROLL parameter. Roll values between MIN− and MIN+ are not a member of excessive ROLL and, thus, can be assigned a value of 0. Roll values between MIN and MAX in either direction can be assigned an escalating value of excessive membership until a value of 1 is reached at +/−MAX.

In some implementations, potential aircraft distress scenarios can be predetermined, and rules-based set operations can be applied to the natural language state parameter values to determine the inference of each distress scenario being tested. These rules can be assigned depending on the condition to be tested, the type of aircraft, the nominal operating parameters and its flight mission. The set operators can be natural language terms expressed as IF-THEN, OR, AND, NOT Rules and operate according to conditional membership statements that include fuzzy logic.

In some implementations, expert knowledge can be applied to the assessment of each parameter's excessive, normal or marginal membership value and its comparison to other values to determine the contribution to each distress scenario.

In some implementations, each distress processing module can independently operate on three sources of data: two from the aircraft MAUs; and one from internal sensors. For a distress inference to be valid, all valid (meaning non-faulted) sources must satisfy the scenario criteria. Determining fault status can be multifaceted:
The data source (internal IMU/GPS, or MAU) can transmit an internally determined valid/invalid status for each monitored parameter.
Additionally, the distress processing modules can examine the frequency of parameter updates to ensure that the current value has been received within acceptable window and is not out of date/stale.
Finally, the distress processing module can compare the incoming parameters against each source to determine agreement.
   This approach of validating aircraft parameter input in redundancy can eliminate nuisance triggers due to invalid input.

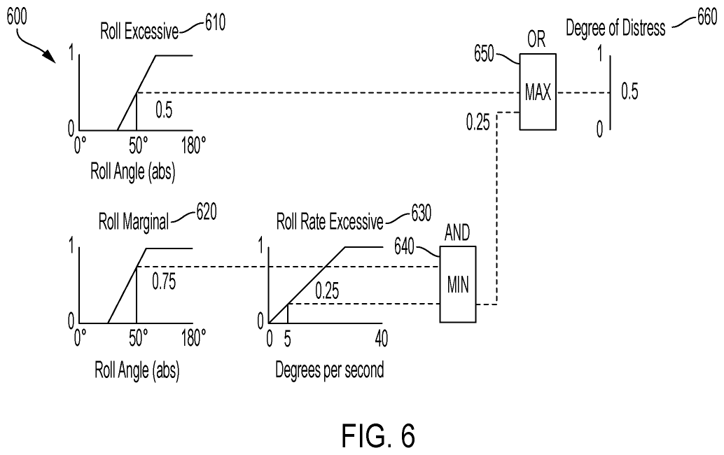

Referring now to FIG. 6, shown is a schematic of an example calculation 600 of a degree of distress 660 using a fuzzy logic algorithm based on roll excessive 610, roll marginal 620 and roll rate excessive 630. The degree of distress 660 is calculated as being roll excessive 610 OR 650 (roll marginal 620 AND 640 roll rate excessive 630). FIG. 6 demonstrates the degree of distress computed by the Excessive Bank FIS for 50 degrees of roll with a roll rate of 5 degrees per second. The Roll Marginal and Roll Rate Excessive fuzzy variables are combined with the AND operator and this truth value is then combined with the Roll Excessive fuzzy variable using the OR operator in order to compute the degree of distress.

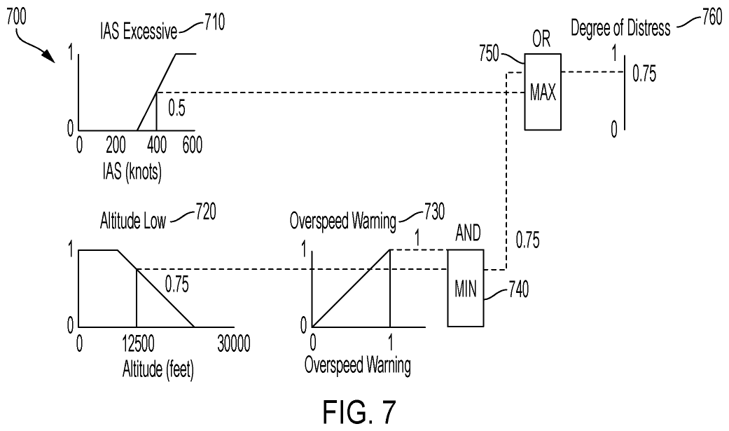

Referring now to FIG. 7, shown is a schematic of an example calculation 700 of a degree of distress 760 using a fuzzy logic algorithm based on IAS excessive 710, altitude low 720 and over speed warning 730. The degree of distress 760 is calculated as being IAS excessive 710 OR 650 (over speed warning 730 AND 640 altitude low 720). FIG. 7 demonstrates the degree of distress computed by the Overspeed FIS with an IAS value of 400 kt, an altitude value of 12500 ft and an Overspeed Warning value of 1 (true). The Overspeed Warning True and Altitude Low fuzzy variables are combined with the AND operator and this truth value is then combined with the IAS Excessive fuzzy variable using the OR operator in order to compute the degree of distress.

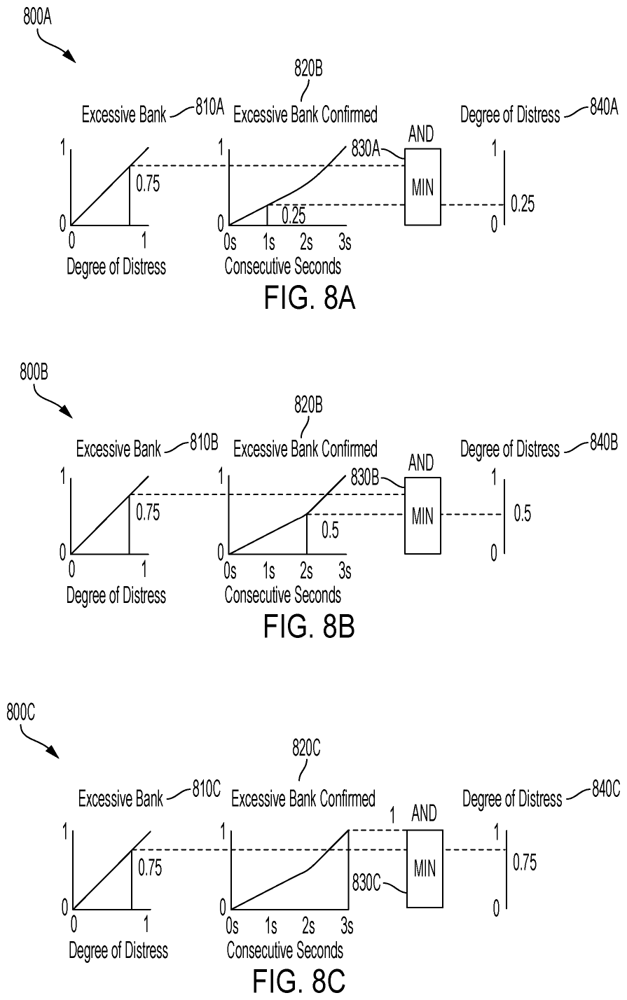

Referring now to FIG. 8A to FIG. 8C, shown are schematics of example calculations 800A-C of degrees of distress 840A-C using fuzzy logic algorithms based on excessive bank 810A-C and excessive bank confirmed 820A-C. The degree of distress 840A-C is calculated as being excessive bank 810A-C AND 830A-C excessive bank confirmed 820A-C. Note that the Excessive Bank Confirmed fuzzy variable's truth value is 1 when the 3 second confirmation time has been reached and is lesser or equal to 0.5 otherwise. Also note that its truth value increases as the confirmation time is approached.

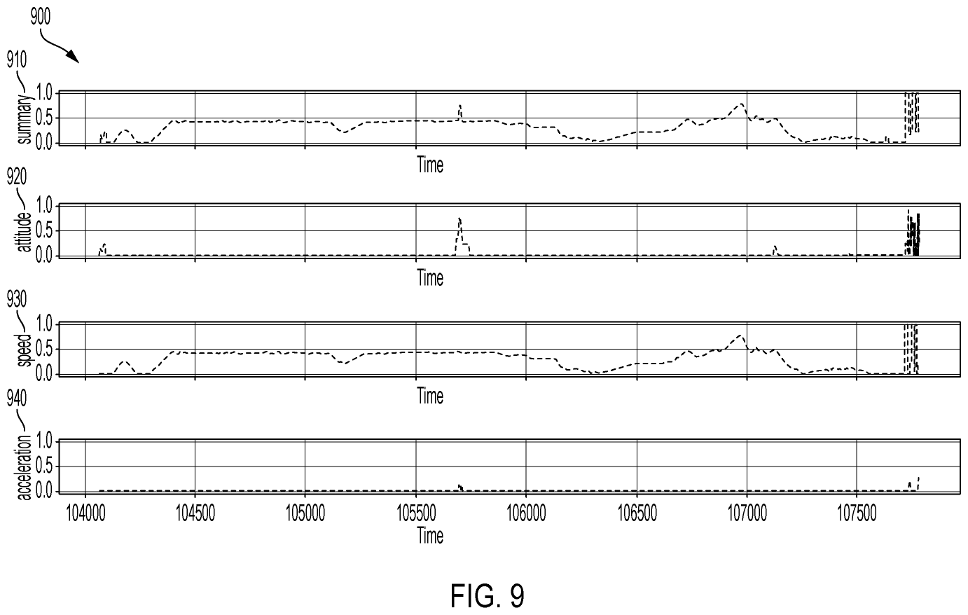

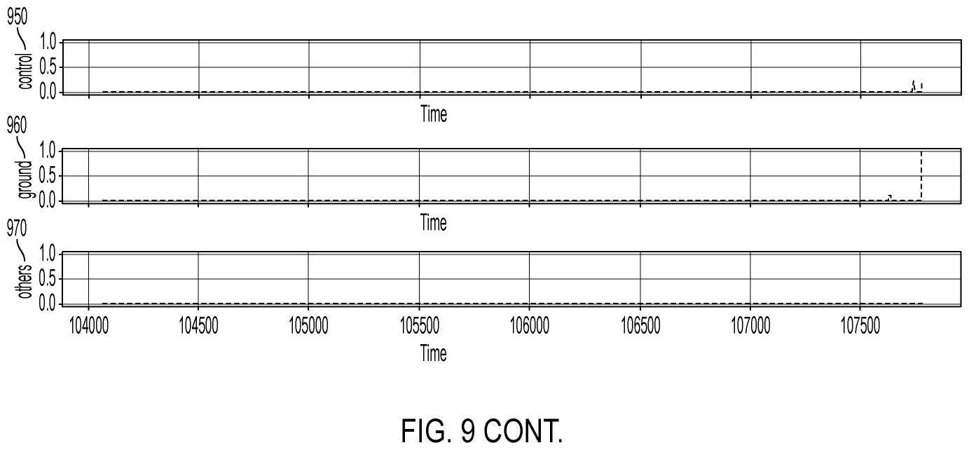

Referring now to FIG. 9, shown are graphs 900 depicting a distress inference 910 over time. These graphs 900 depict an inference output 910 for a plurality of scenario conditions being tested, including attitude 920, speed 930, acceleration 940, control 950, ground 960, and others 970. Values can range from “0” for no-inference of distress to “1” for certainty in inference of distress for said scenario.

### Other Systems and Methods

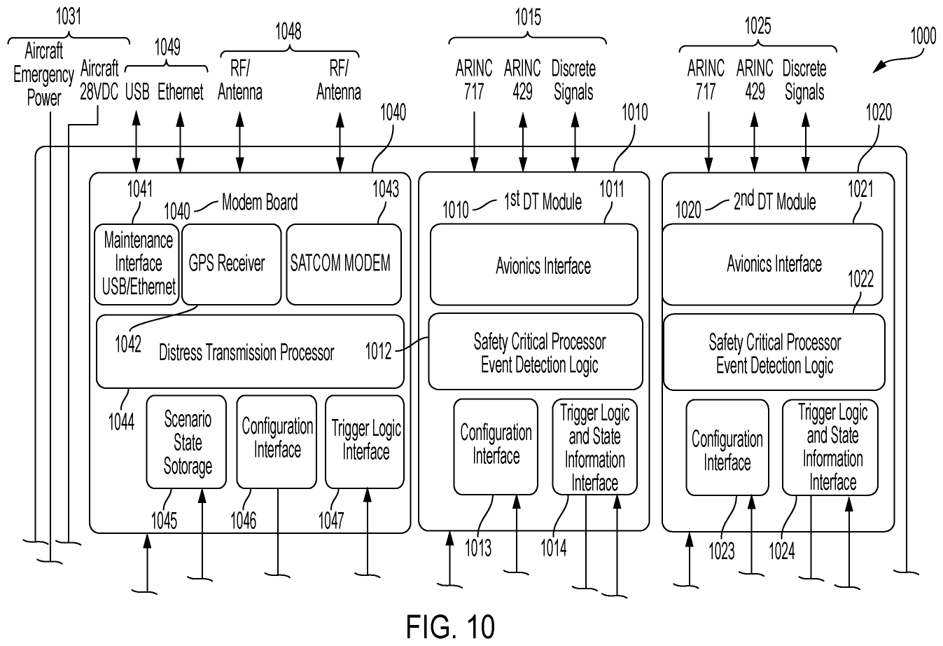

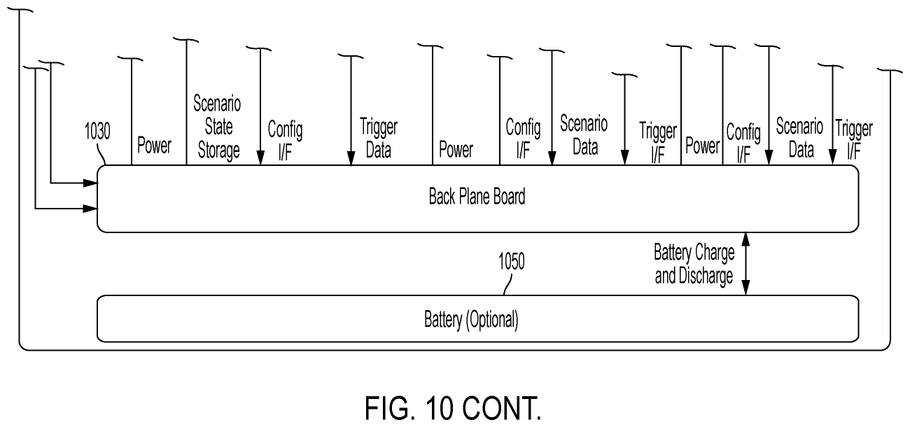

Referring now to FIG. 10, shown is a block diagram of another system 1000 for autonomously tracking distress events on an aircraft in real-time while in flight. The system 1000 has redundant DT (distress trigger) modules, including a first DT module 1010 and a second DT module 1020, operatively coupled to a modem board 1040 via a back plane board 1030. It is to be understood that the system 1000 is very specific and is provided merely as an example.

Each DT module 1010,1020 has an avionics interface 1011,1021 configured to communicate with MAUs (not shown) disposed in the aircraft and to receive data 1015,1025 generated by the MAUs relating to operational parameters of the aircraft. Each DT module 1010,1020 also has a processor 1012,1022 having safety critical processor event detection logic for processing the data 1015,1025 received from the MAUs using in-flight event detection and triggering criteria to produce scenario data and trigger data. Each DT module 1010,1020 also has a configuration interface 1013,1023 and a trigger logic and state information interface 1014,1024 for interfacing with the back plane board 1030.

The modem board 1040 has a scenario state storage 1045 for receiving scenario data and trigger data generated by the DT modules 1010,1020, a configuration interface 1046, and a trigger logic interface 1047 for interfacing with the back plane board 1030. The modem board 1040 also has a distress transmission processor 1044, a GPS receiver 1042, and a Satcom (satellite communications) modem 1043, which connect to RF (radio frequency) antennas 1048 for wireless communication. The modem board 1040 also has a maintenance interface 1041, which can connect to USB and/or Ethernet cables 1049 for maintenance purposes.

The back plane board 1030 provides protection circuitry, power regulation and distribution, and data communication. In some implementations, back plane board 1030 has connections 1031 for receiving 28V DC power from the aircraft, and aircraft emergency power as well. In some implementations, the system 1000 also has a battery 1050 for delivering power to the system 1000 via the back plane board 1030. The battery 1050 can be used in addition to, or instead of, the connections 1031.

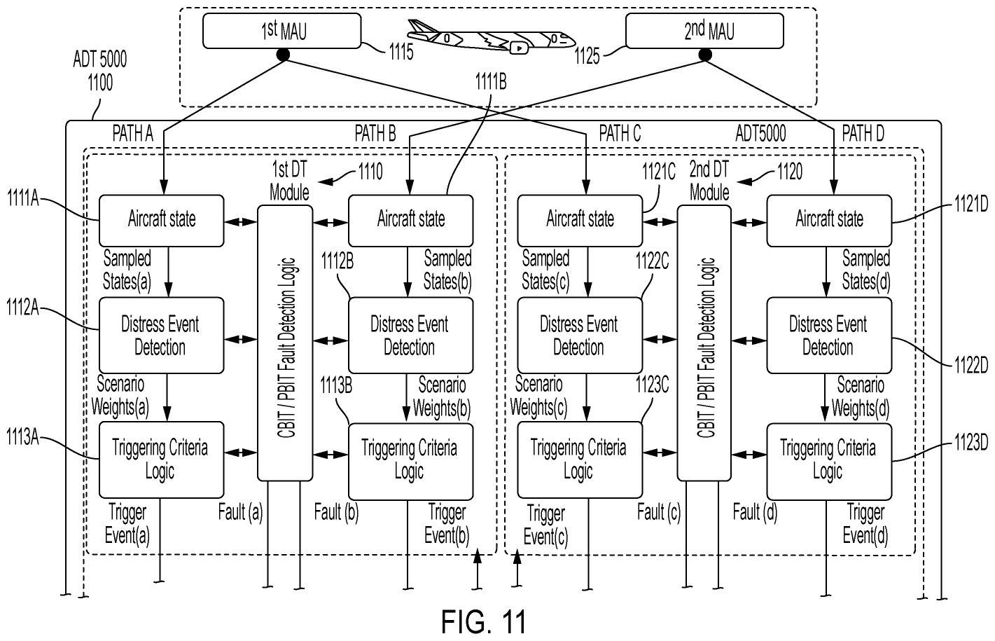

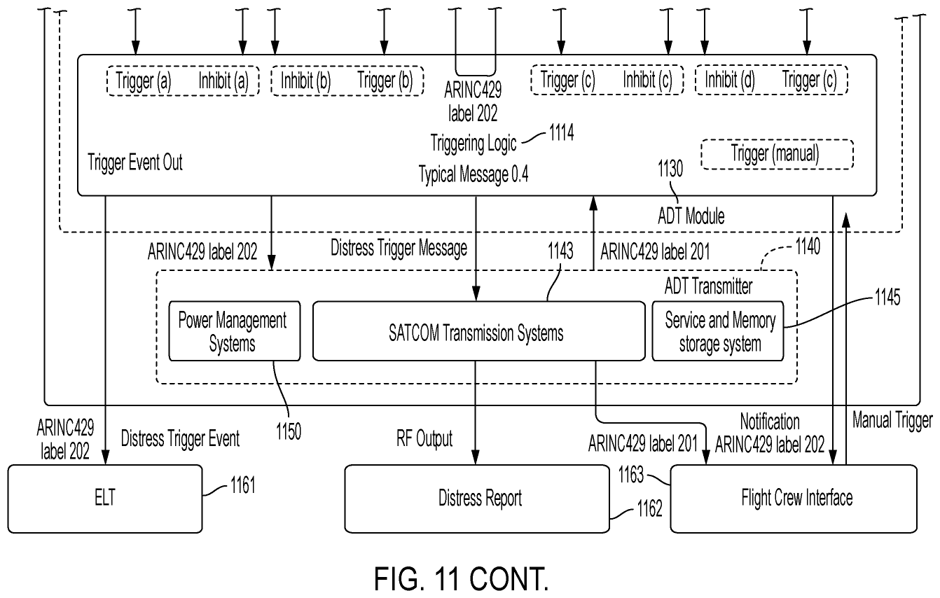

Referring now to FIG. 11, shown is a block diagram of another system 1100 for autonomously tracking distress events on an aircraft in real-time while in flight. In the illustrated example, aircraft states are sampled in a redundant manner utilizing dissimilar data sources of the same parameters. This is indicated by functional paths A, B, C and D collecting data from a first MAU 1115 and a second MAU 1125. The cross-connected configuration depicted in FIG. 10 can allow the two-processing modules 1110,1120 to individually monitor the same source data. It is to be understood that the system 1100 is very specific and is provided merely as an example.

The first DT module 1110 has fault detection logic 1112 that processes the data in stages: a first stage 1111A,1111B for sampling aircraft state data, a second stage 1112A,1112B for applying weights for distress event detection, and a third stage 1113A,1113B for triggering a distress event. The second DT module 1120 likewise has fault detection logic 1122 that processes the data in stages: a first stage 1121C,1121D for sampling aircraft state data, a second stage 1122C,1122D for applying weights for distress event detection, and a third stage 1123C,1123D for triggering a distress event.

Data generated by paths A, B, C and D are received by triggering logic 1114, which conducts a DT event vote on that data. If the event vote results in a passing vote, meaning a distress event has been detected, then a trigger event is generated by the triggering logic 1114. If the event vote results in a failed vote, then no trigger event is generated by the triggering logic 1114.

When a trigger event is generated by the triggering logic 1114, an alert of the trigger event is generated. There are many possibilities for the alert of the trigger event. In some implementations, the ADT module 1130 provides the trigger event to an ELT (emergency locator transmitter) 1161 for transmission. In some implementations, the ADT module 1130 provides the trigger event to ADT transmitter 1140, which includes a Satcom transmission system 1143, for transmitting the trigger event in a distress report 1162. The ADT transmitter 1140 also has power management systems 1150 and a service and memory storage system 1145. In some implementations, the ADT module 1130 provides the trigger event to a flight crew interface 1163 to inform the flight crew. In some implementations, the ADT module 1130 provides the trigger event to an ADS-B (automatic dependent surveillance-broadcast) transmission system for transmitting the trigger event (not shown). Other implementations are possible and are within the scope of the disclosure. For example, in another implementation, a cellular transmission system (not shown) is used to transmit the trigger event.

The systems 1000,1100 depicted in FIG. 10 and FIG. 11 can monitor aircraft parameters in order to determine present aircraft state or condition. The aircraft parameters can include, but are not limited to, those specified in EUROCAE guidelines ED-237, which are incorporated by reference into this application in their entirety. This state information can be primarily extracted from the on-board avionics via an applicable avionics data bus interface. It is anticipated that the aircraft provides said parameters. In addition, the described systems 1000,1100 can have power supplies, internal GPS receivers and IMU devices that can permit general aircraft state to be determined autonomously should the aircraft avionics no longer provide reliable data.

Upon initial power up, the system 1100 can determine whether it was initiated with normal aircraft power or from emergency aircraft power. If the system has powered up with a power state fault, that is, powered up with emergency aircraft power, then the distress state is asserted and the triggers are sent. If the system has powered up without a power state fault, it can proceed to check Aircraft State interfaces and Logic circuits.

In some embodiments, hardware interface tests can be conducted both as loop-backs and cross-feeds for all signalling technologies. If the processing modules detect fault, the system can update logs and alert maintenance crew in addition to alerting the flight crew of the fault. The system can operate with one processing path in fault condition. Having both processing modules in fault is a system fail.

If the startup hardware system checks are successful, then the next stage is to validate whether the stored program logic for determining distress is valid (for example, whether the code matches checksum tests). In some embodiments, the system 1100 can have a database of predetermined parameters that can pertain to both distress and non-distress conditions. The system 1100 with a priori knowledge of the expected distress inferences can apply the database files to the redundant processing paths. In some implementations, a fault detection subsystem can compare calculated inferences, and can further assess the health of the system based on the expected known values. Processing paths not achieving the expected values can be placed in fault condition.

Any path found to be in fault, for either deficient hardware or software reasons, can be demerited from participating in the aircraft state of distress inference calculations.

To ensure the sampled aircraft state data is available and coming from reliable sources, the redundant processing paths can apply ‘marked data’ to the avionics data sources being monitored. Failure to detect the marked frames can result in a fault condition. The system can assess this condition as a disconnect or avionics bus failure.

Similar to power up testing described earlier, the system 1100 can continuously check each processing path for its ability to calculate a correct distress inference from a known database of aircraft parameters. The continuous version of the test can proceed with the (marked) parameters being injected into the processing path under evaluation. As the data can provide or create an inference known a priori, the processing path under test can be assessed for its ability to achieve the expected inference value. Processing Paths not achieving said inference can be marked as being in fault. In a fault condition, the processing path is excluded from the inference calculations. In other words, the injected parameters are known ahead of time to be expected to result in a distress state, therefore, the distress state triggering is ignored by the system, or causes a fault state for the processing path if it is not observed as expected.

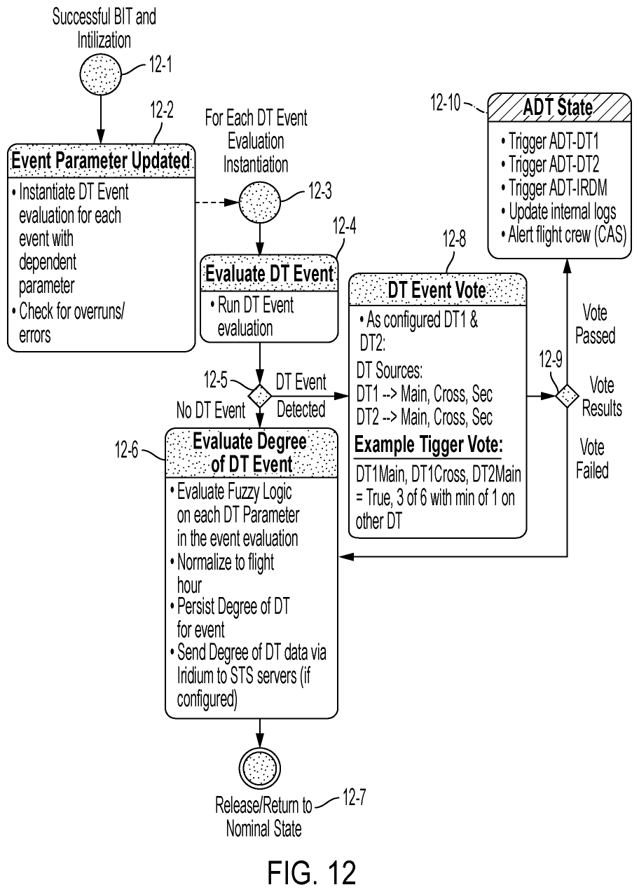

Referring now to FIG. 12, shown is a flow chart of another method for autonomously tracking distress events on an aircraft in real-time while in flight. After a successful initialization and running of the built-in test at step 12-1, each received DT event can be evaluated and checked for any overruns or errors at steps 12-2 to 12-4. If a DT event has been detected at step 12-5, then the system conducts a DT event vote on the data generated by the DT modules at step 12-8. If the event vote results in a passing vote at step 12-9, meaning a distress event has been detected, then at step 12-10 a trigger event is generated by the DT modules and is logged along with an alert being provided to the flight crew. If the event vote results in a failed vote at step 12-9, meaning no distress event has been detected, then at step 12-6 the system evaluates the degree of the DT event by evaluating the fuzzy logic on each DT parameter in the event evaluation.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can include RAM (random access memory), ROM (read only memory), EEPROM (electrically erasable programmable read-only memory), CD-ROM (compact disc read-only memory) or other optical disk storage, magnetic disk storage or other magnetic storage devices, or any other tangible storage medium that can be used to store desired program code in the form of instructions or data structures and that can be accessed by a computer or processor. Disk and disc, as used herein, include CD (compact disc), laser disc, optical disc, DVD (digital versatile disc), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Numerous modifications and variations of the present disclosure are possible in light of the above teachings. It is therefore to be understood that within the scope of the appended claims, the disclosure may be practised otherwise than as specifically described herein.

1. A method for autonomously tracking distress events on an aircraft in real-time while in flight, the aircraft comprising at least one MAU (main avionics unit) configured for gathering and processing aircraft state data, the method comprising:
maintaining a multi-valued logic classifier configured for identifying distress events using more than two possible truth values;
receiving the aircraft state data from the at least one MAU;
transforming the aircraft state data using the multi-valued logic classifier to produce transformed state data;
producing a trigger event when the transformed state data indicates a distress event; and
generating an alert of the trigger event.

2. The method of claim 1, wherein generating the alert comprises passing the trigger event to an emergency locator transmitter for transmission.

3. The method of claim 1, wherein generating the alert comprises transmitting the trigger event.

4. The method of claim 3, wherein transmitting the trigger event comprises transmitting the trigger event via at least one of a Satcom (satellite communication) transmission system, an ADS-B (automatic dependent surveillance-broadcast) transmission system, and a cellular transmission system.

5. The method of claim 1, further comprising:
storing distress event data and the aircraft state data relating to the distress event;
wherein maintaining the multi-valued logic classifier comprises updating the multi-valued logic classifier, in accordance with the distress event data and the aircraft state data.

6. The method of claim 1, wherein the multi-valued logic classifier comprises a fuzzy logic algorithm incorporating fuzzy rules that apply membership functions to the aircraft state data to produce the transformed state data.

7. The method of claim 6, further comprising:
storing distress event data and the aircraft state data relating to the distress event;
wherein maintaining the multi-valued logic classifier comprises adjusting the membership functions, in accordance with the distress event data and the aircraft state data.

8. The method of claim 1, wherein the multi-valued logic classifier comprises an artificial neural network algorithm incorporating functions based on weighted combinations of the aircraft state data.

9. The method of claim 8, further comprising:
storing distress event data and the aircraft state data relating to the distress event;
wherein maintaining the multi-valued logic classifier comprises adjusting the weighted combinations, in accordance with the distress event data and the aircraft state data.

10. The method of claim 1, wherein:
the at least one MAU comprises a first MAU and a second MAU;
receiving the aircraft state data from the at least one MAU comprises (i) receiving first aircraft state data from the first MAU, and (ii) receiving second aircraft state data from the second MAU;
transforming the aircraft state data using the multi-valued logic classifier to produce transformed state data comprises (i) transforming the first aircraft state data using a first multi-valued logic classifier to produce first transformed state data, and (ii) transforming the second aircraft state data using a second multi-valued logic classifier to produce second transformed state data; and
producing the trigger event if the transformed state data indicates the distress event comprises (i) comparing the first transformed state data to the second transformed state data, and (ii) producing the trigger event if the first transformed state data and the second transformed state data match each other and they both indicate the distress event.

11. A non-transitory computer readable medium having recorded thereon statements and instructions that, when executed by a processor of a system, implement the method of claim 1.

12. A system for autonomously tracking distress events on an aircraft in real-time while in flight, the aircraft comprising at least one MAU (main avionics unit) configured for gathering and processing aircraft state data, the system comprising:
a multi-valued logic classifier configured for identifying distress events using more than two possible truth values;
an avionics interface for receiving the aircraft state data from the at least one MAUs; and
a processor for transforming the aircraft state data using the multi-valued logic classifier to produce transformed state data, and for producing a trigger event when the transformed state data indicates a distress event; and
an alert interface for generating an alert of the trigger event.

13. The system of claim 12, wherein the alert interface generates the alert by passing the trigger event to an emergency locator transmitter for transmission.

14. The system of claim 12, wherein the alert interface comprises a transmitter for transmitting the trigger event.

15. The system of claim 14, wherein the transmitter comprises at least one of a Satcom (satellite communication) system, an ADS-B (automatic dependent surveillance-broadcast) transmission system, and a cellular transmission system.

16. The system of claim 12, further comprising:
a memory for storing distress event data and the aircraft state data relating to the distress event;
wherein the multi-valued logic classifier is configured to be updated, in accordance with the distress event data and the aircraft state data.

17. The system of claim 12, wherein the multi-valued logic classifier comprises a fuzzy logic algorithm incorporating fuzzy rules that apply membership functions to the aircraft state data to produce the transformed state data.

18. The system of claim 17, further comprising:
a memory for storing distress event data and the aircraft state data relating to the distress event;
wherein the multi-valued logic classifier is configured to be updated by adjusting the membership functions, in accordance with the distress event data and the aircraft state data.

19. The system of claim 12, wherein the multi-valued logic classifier comprises an artificial neural network algorithm incorporating functions based on weighted combinations of the aircraft state data.

20. The system of claim 19, further comprising:
a memory for storing distress event data and the aircraft state data relating to the distress event;
wherein the multi-valued logic classifier is configured to be updated by adjusting the weighted combinations, in accordance with the distress event data and the aircraft state data.

21. The system of claim 12, wherein:
the at least one MAU comprises a first MAU and a second MAU;
the avionics interface comprises (i) a first avionics interface for receiving first aircraft state data from the first MAU, and (i) a second avionics interface for receiving second aircraft state data from the second MAU;
the multi-valued logic classifier comprises (i) a first multi-valued logic classifier and (ii) a second multi-valued logic classifier;
the processor comprises (i) a first processor for transforming the first aircraft state data using the first multi-valued logic classifier to produce first transformed state data, and (ii) a second processor for transforming the second aircraft state data using the second multi-valued logic classifier to produce second transformed state data; and
wherein the system comprises triggering logic that produces the trigger event by (i) comparing the first transformed state data to the second transformed state data, and (ii) producing the trigger event if the first transformed state data and the second transformed state data match each other and they both indicate the distress event.

22. The system of claim 21, wherein:
the first avionics interface, the first multi-valued logic classifier, and the first processor are part of a first distress trigger module, and the first multi-valued logic classifier is implemented using the first processor;
the second avionics interface, the second multi-valued logic classifier, and the second processor are part of a second distress trigger module, and the second multi-valued logic classifier is implemented using the second processor; and
the system further comprises a backplane coupled to the first distress trigger module, the second distress trigger module, and the alert interface.

23. The system of claim 12, wherein the multi-valued logic classifier is software-based and executed on the processor, and wherein maintaining the multi-logic classifier comprises storing software and any associated configurations of the multi-logic classifier in memory.
